(19) United States
(12) Patent Application Publication
(10) Pub. No.: US 2025/0237756 A1
(43) Pub. Date: Jul. 24, 2025

(54) SENSING APPARATUS AND METHOD BASED ON PHOTOACOUSTIC ULTRASONIC SENSOR

(71) Applicant: SAMSUNG ELECTRONICS CO., LTD., Suwon-si (KR)

(72) Inventors: Sang Yun PARK, Suwon-si (KR); Byung Hoon KO, Suwon-si (KR); Seung Woo NOH, Suwon-si (KR); Jin Woo CHOI, Suwon-si (KR); Hyun Il BYUN, Suwon-si (KR)

(73) Assignee: SAMSUNG ELECTRONICS CO., LTD., Suwon-si (KR)

(21) Appl. No.: 18/828,714

(22) Filed: Sep. 9, 2024

(30) Foreign Application Priority Data
Jan. 22, 2024 (KR) 10-2024-0009575

(51) Int. Cl. G01S 7/534; G01S 7/56; G01S 15/34

(52) U.S. Cl. CPC G01S 7/534; G01S 15/34; G01S 7/56

(57) ABSTRACT

A photoacoustic ultrasonic sensor-based sensing apparatus may include a signal generator configured to generate an ultrasonic signal; a transmitter configured to emit the ultrasonic signal; a receiver configured to receive an echo signal that occurs when the ultrasonic signal is reflected from an object; and a photoacoustic ultrasonic sensor configured to measure a light signal modulated based on at least one of the ultrasonic signal or the echo signal.

### CROSS-REFERENCE TO RELATED APPLICATION(S)

This application claims priority to Korean Patent Application No. 10-2024-0009575, filed on Jan. 22, 2024, in the Korean Intellectual Property Office, the disclosure of which is incorporated herein by reference in its entirety.

### BACKGROUND

### Field

Apparatuses and methods consistent with one or more example embodiments relate to an object sensing device and method based on a photoacoustic ultrasonic sensor.

### Description of Related Art

Ultrasonic sensors may measure a distance to a target object by emitting ultrasonic waves to the target object and detecting the ultrasonic waves reflected back from it, allowing the distance to be determined based on the time taken for the waves to return. Although the method of distance measurement using ultrasonic sensors may be relatively simple and inexpensive to set up, it has limitations such as restricted measurement distance and resolution. The ultrasonic waves emitted by conventional ultrasonic sensors may experience changes in speed and energy due to the acoustic propagation characteristics in air or other mediums, leading to errors in distance measurement.

### SUMMARY

According to an aspect of the present disclosure, a photoacoustic ultrasonic sensor-based sensing apparatus may include: a signal generator configured to generate an ultrasonic signal; a transmitter configured to emit the ultrasonic signal; a receiver configured to receive an echo signal that occurs when the ultrasonic signal is reflected from an object; and a photoacoustic ultrasonic sensor configured to measure a light signal modulated based on at least one of the ultrasonic signal or the echo signal.

The photoacoustic ultrasonic sensor may further include: a light source configured to generate light and modulate the light using the ultrasonic signal to obtain a first modulated light signal, an ultrasonic transducer configured to modulate the first modulated light based on the echo signal to obtain a second modulated light signal, and a light sensor configured to measure the second modulated light signal.

The light generated by the light source may include laser light.

The light source may be synchronized with a transmitter driving signal that is output from the signal generator to modulate the light using the ultrasonic signal.

The ultrasonic transducer may include an optical waveguide configured to transmit the light from the light source to the light sensor.

The ultrasonic transducer may include a modulation structure configured to module an amplitude of light moving through the optical waveguide in response to an input of the echo signal.

The modulation structure may include at least one of a deformable body that undergoes mechanical deformation due to the echo signal, a resonator, and a coupler configured to couple the resonator to the optical waveguide.

The photoacoustic ultrasonic sensor-based sensing apparatus may include a filter configured to filter the light signal measured by the photoacoustic ultrasonic sensor to output a beat frequency signal.

The photoacoustic ultrasonic sensor-based sensing apparatus may include an analog-to-digital converter (ADC) configured to convert the light signal measured by the photoacoustic ultrasonic sensor into a digital signal.

The photoacoustic ultrasonic sensor-based sensing apparatus may include a processor configured to process the light signal measured by the photoacoustic ultrasonic sensor.

The transmitter and the receiver may constitute a plurality of channels, and the photoacoustic ultrasonic sensor may include a first light source configured to generate a first light and modulate the first light based on the ultrasonic signal to obtain a first modulated light signal, a plurality of ultrasonic transducers configured to modulate the first modulated light signal based on echo signals received from the plurality of channels to obtain a second modulated light signal, and a light sensor configured to measure the second modulated light signal that is modulated by the plurality of ultrasonic transducers.

The light sensor may be configured to measure the second modulated light signal that is obtained by modulating the first modulated light signal using one of the echo signals that is received from a channel selected according to a channel select signal, among the plurality of channels.

The first light source may be configured to select the channel by adjusting a wavelength of the first light according to the channel select signal.

The photoacoustic ultrasonic sensor-based sensing apparatus may include a second light source configured to generate a second light for selecting the channel by adjusting a wavelength of the second light according to the channel select signal.

The second light source may be configured to modulate the second light using the ultrasonic signal generated by the signal generator.

Sizes of the plurality of ultrasonic transducers may be set differently to correspond to different resonance wavelengths.

The plurality of ultrasonic transducers may include one or more optical waveguides that transmit the first light from the first light source to the light sensor.

According to another aspect of the present disclosure, a photoacoustic ultrasonic sensor-based sensing method may include: generating an ultrasonic signal using a signal generator; emitting, by a transmitter, the ultrasonic signal; receiving, at a receiver, an echo signal that occurs when the ultrasonic signal is reflected from an object; and measuring, at a photoacoustic ultrasonic sensor, a light signal modulated based on at least one of the ultrasonic signal or the echo signal.

The measuring of the modulated light signal may include modulating the light based on the ultrasonic signal to obtain a first modulated light signal, modulating the first modulated light signal based on the echo signal to obtain a second modulated light signal, and measuring the second modulated light signal.

According to another aspect of the present disclosure, an electronic device may include: a signal generator configured to generate an ultrasonic signal and output the ultrasonic signal through a first route and a second route; a transmitter configured to receive the ultrasound signal through the first route and transmit the ultrasound signal outside the electronic device; a receiver configured to receive an echo signal of the ultrasound signal that is reflected from an object; an photoacoustic ultrasonic sensor configured to generate a light signal, modulate the light signal based on the ultrasound signal received through the second route to obtain a first modulated light signal, and modulate the first modulation light signal based on the echo signal to obtain a second modulated light; a processor configured to determine a distance to the object based on the second modulated light; and a display configured to display information about the distance to the object.

In still another general aspect, there is provided an electronic apparatus including a sensing apparatus configured to measure a frequency-modulated ultrasound-based light signal and a processor configured to perform an operation of the electronic apparatus based on the measured light signal, wherein the sensing apparatus may include a signal generator configured to generate a frequency-modulated ultrasonic signal, a transmitter configured to transmit the generated ultrasonic signal toward an object, a receiver configured to receive an echo signal reflected from the object, and a photoacoustic ultrasonic sensor configured to measure a light signal modulated based on at least one of the generated ultrasonic signal or the received echo signal.

### BRIEF DESCRIPTION OF THE DRAWINGS

The above and/or other aspects will be more apparent by describing certain example embodiments, with reference to the accompanying drawings, in which:

FIGS. 1A and 1B are block diagrams illustrating a photoacoustic ultrasonic sensor-based sensing apparatus according to embodiments;

FIG. 2 is a diagram illustrating a photoacoustic ultrasonic sensor according to an embodiment;

FIGS. 3A and 3B are diagrams illustrating the structure of an ultrasonic transducer according to embodiments;

FIGS. 4A and 4B are diagrams for explaining signals modulated using a photoacoustic ultrasonic sensor;

FIGS. 5A, 5B, and 5C are block diagrams illustrating photoacoustic ultrasonic sensors according to other embodiments;

FIG. 6 is a flowchart illustrating a photoacoustic ultrasonic sensor-based sensing method according to an embodiment;

FIGS. 7A, 7B, and 7C are flowcharts illustrating light signal modulation and measurement according to embodiments; and

FIG. 8 is a block diagram illustrating an electronic apparatus according to an embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Terms such as first, second, and the like may be used to describe various elements, but the elements should not be limited to those terms. These terms may be used for the purpose of distinguishing one element from another element. The singular forms are intended to include the plural forms as well, unless the context clearly indicates otherwise. It will be further understood that when an element is referred to as “comprising” or “including” another element, the element is intended not to exclude one or more other elements, but to further include one or more other elements, unless explicitly described to the contrary. The term used in the embodiments such as “unit” or “module” indicates a unit for processing at least one function or operation, and may be implemented in hardware, software, or in a combination of hardware and software.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

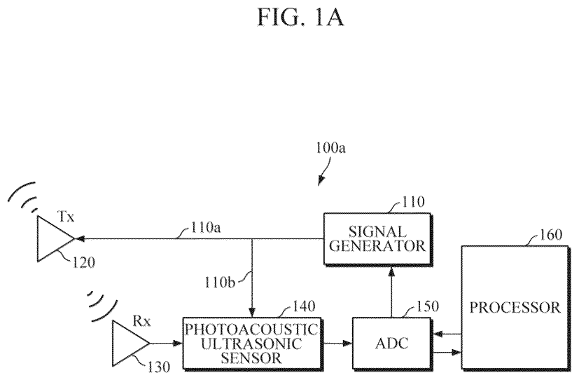

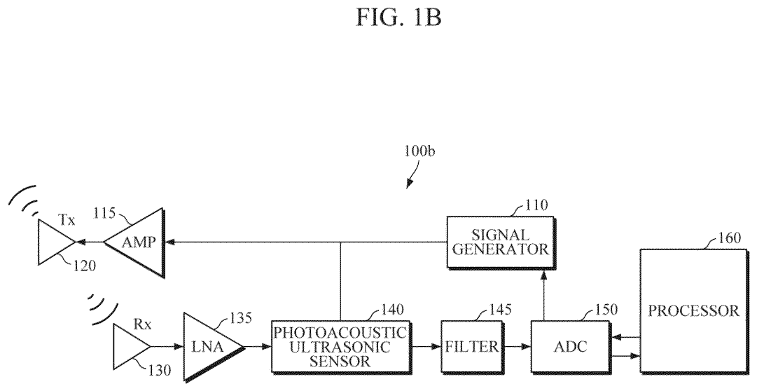

FIGS. 1A and 1B are block diagrams illustrating an photoacoustic ultrasonic sensor-based sensing apparatus according to embodiments.

Referring to FIG. 1A, a photoacoustic ultrasonic sensor-based sensing apparatus 100a may include a signal generator 110, a transmitter 120, a receiver 130, a photoacoustic ultrasonic sensor 140, an analog-to-digital converter (ADC) 150, and a processor 160. Referring to FIG. 1B, a sensing apparatus 100b may further include a power amplifier (AMP) 115, a low noise amplifier (LNA) 135, and a filter 155. The ADC 150 may convert an analog signal to a digital signal and vice versa, despite being referred to as an analog-to-digital converter for simplicity. Each component may be implemented in hardware, software, or in a combination of hardware and software.

The signal generator 110 may generate a frequency-modulated signal. The signal generator 110 may be implemented as an analog circuit including a radio frequency (RF) signal generator, such as a chirp waveform generator and a voltage-controlled local oscillator, to general a frequency-modulated signal and route the frequency-modulated signal to the transmitter 120 and an output antenna through a first route 110a, and to the photoacoustic ultrasonic sensor 140 through a second route 110b. The operation of the signal generator 110 may be controlled by the processor 160, through the ADC 150 which converts a digital command signal into an analog signal to be provided to the signal generator 110. The frequency-modulated signal may be, but is not limited to, a frequency-modulated ultrasonic signal, a radio frequency (RF) radar signal, or the like. The frequency-modulated signal may be a sawtooth wave signal, a triangular wave signal, or a hyperbolic chirp signal. The frequency-modulated signal may be a continuous wave signal or a chirped-pulse signal. For convenience of explanation, a frequency-modulated ultrasonic signal now will be described as an example of a frequency-modulated signal.

Referring to FIG. 1B, the frequency-modulated ultrasonic signal generated by the signal generator 110 may be amplified by the AMP 115 and then transmitted to the transmitter 120.

The transmitter 120 emits the ultrasonic signal received from the signal generator 110 toward an object in response to a driving signal from the signal generator 110. The receiver 130 may receive an echo signal reflected from the object. The receiver 130 may include a micro electro mechanical system (MEMS) sensor, such as a bulk ceramic sensor using piezoelectric ceramics, a microphone, or a piezoelectric micromachined ultrasonic transducer (PMUT)/capacitive micromachined ultrasonic transducer (CMUT), and is not limited thereto. The transmitter 120 and the receiver 130 may each include independent components or parts. They may be configured as a single channel including one transmitter 120 and one receiver 130, or as a multi-channel consisting of a set of one transmitter 120 and multiple receivers 130, a set of multiple transmitters 120 and one receiver 130, or a set of multiple transmitters 120 and multiple receivers 130. The transmitter 120 and the receiver 130 in each channel may be formed separately or integrated into a single package.

The ultrasonic signal generated by the signal generator 110 and/or the echo signal received by the receiver 130 may be input to the photoacoustic ultrasonic sensor 140. The ultrasonic signal generated by the signal generator 110 may be synchronized with the driving signal of the transmitter 120 and input to the photoacoustic ultrasonic sensor 140. The echo signal received by the receiver 130 may be amplified by the LNA 135, as illustrated in FIG. 1B, and input to the photoacoustic ultrasonic sensor 140.

The photoacoustic ultrasonic sensor 140 may generate light, and may modulate the light based on the input ultrasonic signal and/or echo signal to measure the modulated light signal. In this case, the light may be monochromatic light such as laser light, but not limited thereto. The photoacoustic ultrasonic sensor 140 may be synchronized with the driving signal of the transmitter 120 to primarily modulate the amplitude of light based on the input ultrasonic signal, and may secondarily modulate the amplitude of the primarily modulated light based on the echo signal input from the receiver 130. Since optical mixing is performed through the photoacoustic ultrasound sensor 140, a separate electrical mixer may not be required, reducing the complexity and power consumption of the system.

The light signal measured by the photoacoustic ultrasonic sensor 140 may be converted into a digital signal by the ADC 150 and then input to the processor 160. As illustrated in FIG. 1B, a mixed signal, after passing through the filter 145, may be transmitted to the ADC 150 as a beat frequency signal. In particular, the filter 145 may include a low-pass filter, a band-pass filter, or the like.

The processor 160 may process the beat frequency signal, performing signal processing, such as spatial information reconstruction and/or image acquisition (e.g., medical ultrasound image, etc.). Spatial reconstruction may include calculating a distance to an object, detecting a newly appeared object, acquiring object information, such as measuring an object movement speed and angle, multidimensional spatial reconstruction, and the like. The processor 160 may utilize fast Fourier transformation (FFT) for frequency analysis of the beat frequency.

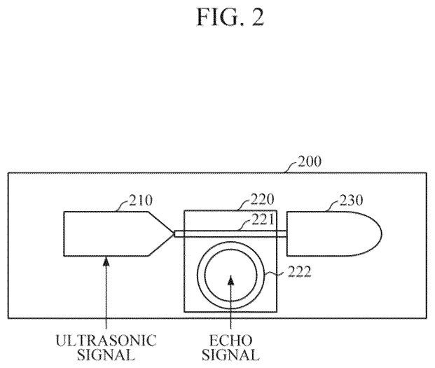

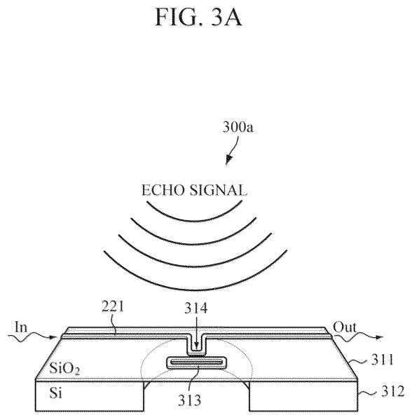

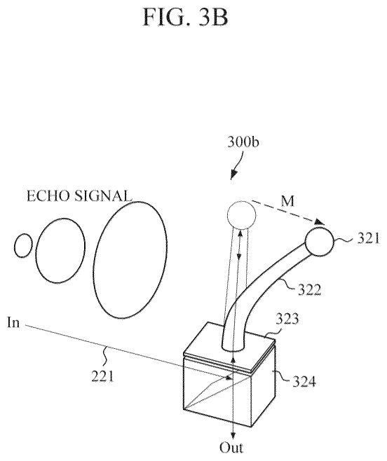

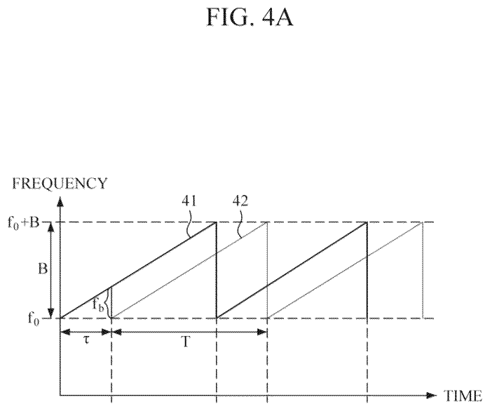

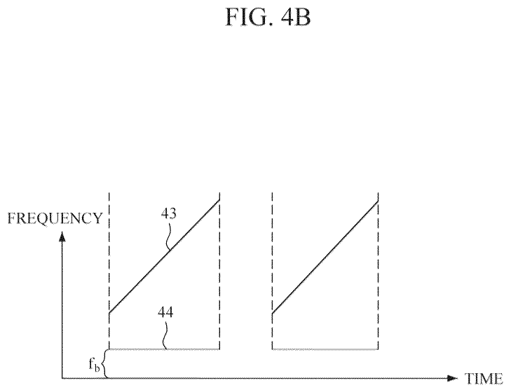

FIG. 2 is a diagram illustrating a photoacoustic ultrasonic sensor according to an embodiment. FIGS. 3A and 3B are diagrams illustrating the structure of an ultrasonic transducer 220 of FIG. 2 according to embodiments. FIGS. 4A and 4B are diagrams for explaining signals modulated using a photoacoustic ultrasonic sensor.

Referring to FIG. 2, a photoacoustic ultrasonic sensor 200 according to an embodiment may include a light source 210, an ultrasonic transducer 220, and a light sensor 230.

The light source 210 may include one or more light sources. The light source may include a light emitting diode (LED), a laser diode (LD), or a phosphor, but is not limited thereto. The light source 210 may emit light of broad wavelength ranges or a relatively narrow, specific wavelength range. In particular, the light may be laser light, but not limited thereto. When the ultrasonic signal generated by the signal generator 110 is input to the light source 120, the light source 210 may be synchronized with the driving signal of the transmitter 120 and may perform amplitude modulation (AM) on the light through the ultrasonic signal.

The ultrasonic transducer 220 may include an optical waveguide 221 and a modulation structure 222. The optical waveguide 221 may transmit the light generated by the light source 210 to the light sensor 230, and the modulation structure 222 may modulate the amplitude of the light transmitted through the optical waveguide 221 using the echo signal. The modulation structure 222 may include various forms of deformable bodies (e.g., a membrane form, a rod form, and the like) that undergoes mechanical deformation due to an echo signal, as well as a resonator, a coupler, a beam splitter, etc., that modulate the amplitude of light according to the mechanical deformation of the deformable body.

In FIG. 2, the ultrasonic signal input to the light source 210 differs from the echo signal input to the ultrasonic transducer 220, in such that the ultrasonic signal input to the light source 210 originates directly from the signal generator 110 or after passing through an internal component of the apparatus 100a, while the echo signal is obtained by emitting the ultrasonic signal from the apparatus 100a outward and subsequently receiving the reflected ultrasonic signal.

Referring to FIG. 3A, the ultrasonic transducer 300a may include a substrate 312, and the modulation structure 222 may be arranged on the substrate 312. The substrate 312 may be a silicon (Si) substrate. A membrane deformable body 311 that undergoes mechanical deformation due to the echo signal may be arranged on the substrate 312, and other structures, such as a resonator 313 and a coupler 314, may be arranged on the membrane deformable body 311. The membrane deformable body 311 may include silicon dioxide (SiO₂), but is not limited thereto. The resonator 313 may have a ring shape, but is not limited thereto. As illustrated, the optical waveguide 221 may be arranged to pass next to the resonator 313 on the membrane deformable body 311 and coupled to the resonator 313 by the coupler 314. The membrane deformable body 311 may be deformed by the echo signal, causing a change in coupling between the resonator 313 placed on the membrane deformable body 311 and the optical waveguide 221. As a result, light of a specific frequency input into the entrance (In) of the optical waveguide 221 may be modulated in amplitude and output to the exit (Out).

Referring to FIG. 3B, an ultrasonic transducer 300b may include a rod-shaped deformable body 322. The rod-shaped deformable body 322 may be a polydimethylsiloxane (PDMS) micropillar. A structure such as an Ag-coated microsphere 321 may be arranged on the rod-shaped deformable body 322. In addition, below the rod-shaped deformable body 322, a glass substrate 323 and a beam splitter 324 may be arranged. When the rod-shaped deformable body 322 bends due to the echo signal, the light input to the entrance (In) of the optical waveguide 221 undergoes a change in total reflection conditions according to the degree M of bending of the rod-shaped deformable body 322. As a result, light may be modulated in amplitude and then output to the exit (Out) of the optical waveguide 221.

FIGS. 3A and 3B only illustrate examples of structures inducing amplitude modulation of light in the ultrasonic transducer 220 of FIG. 2, but are not limited thereto.

Referring back to FIG. 2, the light sensor 230 may measure an optically mixed light signal modulated in the light source 210 and the ultrasonic transducer 220. In the present disclosure, modulation occurring in the light source 210 may be referred to as primary modulation or first modulation, and modulation occurring in the ultrasonic transducer 220 may be referred to as secondary modulation or second modulation. The light sensor 230 may convert the measured light signal into an electrical signal and output the electrical signal. The output electrical signal may be transmitted to the processor 160 through the filter 145 and/or the ADC 150. The light sensor 230 may include a photodiode, a photo transistor, an image sensor (e.g., complementary metal-oxide semiconductor (CMOS)), and the like.

FIGS. 4A and 4B are diagrams for explaining signals modulated using a photoacoustic ultrasonic sensor. FIG. 4A represents a primarily modulated light signal 41 obtained by inputting a frequency-modulated ultrasonic signal to the light source 210, and an echo signal 42 received from the receiver 130 and input to the ultrasonic transducer 220. The primarily modulated light signal 41 may be also referred to as a first modulated light signal. The frequency-modulated ultrasonic signal may be a local oscillator signal derived directly from the signal generator 110, while the echo signal 43 may be obtained by transmitting the local oscillator signal towards a target object and subsequently receiving the reflected oscillator signal returned from the target object.

In FIG. 4A, B represents a frequency bandwidth, T represents a period, τ represents the time for the ultrasonic signal to be reflected back from an object, f₀ represents an initial frequency, and f_{b} represents a tone frequency. FIG. 4B shows a high-frequency component 43 and a low-frequency component 44 of an optically mixed signal after secondary modulation based on the echo signal in the ultrasonic transducer 220, and represents the signal to be measured by the light sensor 230. The signal measured by the light sensor 230 may be utilized for reconstructing spatial information by filtering out desired frequency components (e.g., low-frequency component) using a filter (e.g., band-pass filter).

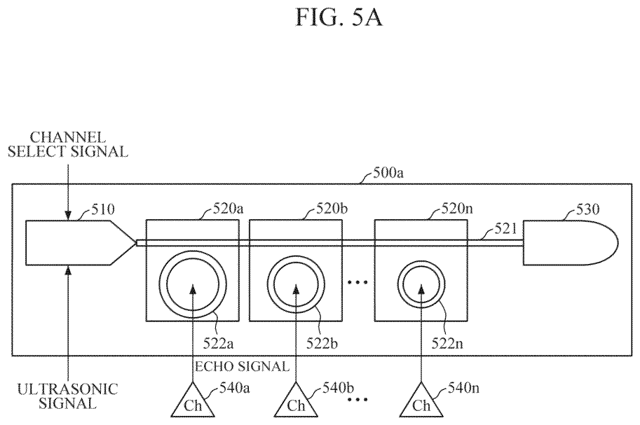

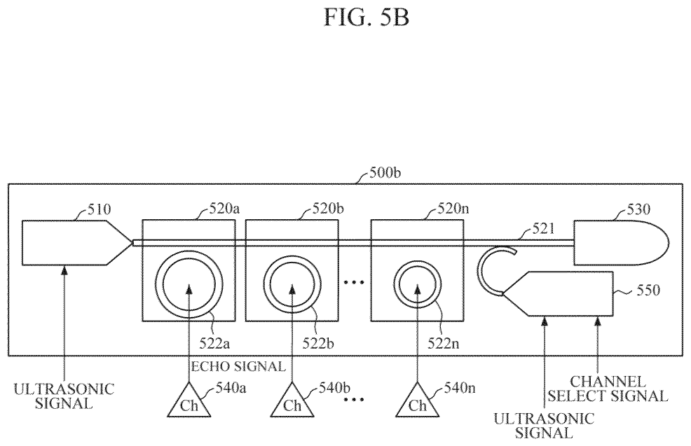

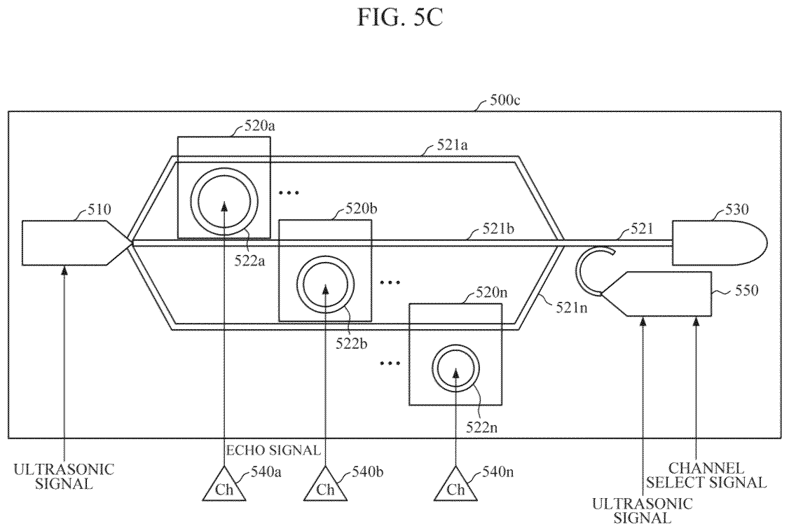

FIGS. 5A to 5C are block diagrams illustrating photoacoustic ultrasonic sensors according to embodiments of the disclosure. In one or more embodiments shown in FIGS. 5A to 5C, wavelength division multiplexing (WDM) may be to allocate the positions of the photoacoustic ultrasonic sensor based on wavelengths.

Referring to FIG. 5A, the photoacoustic ultrasonic sensor 500a may include a light source 510, a plurality of ultrasonic transducers 520a, 520b, . . . , and 520n, and a light sensor 530.

The light source 510 may generate light and modulate the generated light using the ultrasonic signal generated by the signal generator 110. Additionally, a channel select signal may be input to the light source 510. The channel select signal may be generated by the processor 160 of FIG. 1. The channel select signal may contain information on the wavelength band of the light source 510. The light source 510 may generate light by adjusting the wavelength according to the channel select signal.

Sets of transmitters 120 and receivers 130 may form a plurality of channels 540a, 540b, . . . , and 540n. The channels 540a, 540b, . . . , and 540n may be formed by a set of one transmitter 120 and multiple receivers 130, a set of multiple transmitters 120 and one receiver 130, or a set of multiple transmitters 120 and multiple receivers 130. The same number of ultrasonic transducers 520a, 520b, . . . , and 520n as the number of the channels 540a, 540b, . . . , and 540n are formed to respectively correspond to the channels. The plurality of ultrasonic transducers 520a, 520b, . . . , and 520n may share one optical waveguide 521. Structures 522a, 522b, . . . , and 522n of the plurality of ultrasonic transducers 520a, 520b, . . . , and 520n may be formed in different sizes. For example, different resonance wavelengths may be achieved by varying the radii of ring resonators.

The light sensor 530 may detect a light signal modulated in the ultrasonic transducer 520a, 520b, . . . , or 520n corresponding to the channel selected by the light source 510. In other words, the light sensor 530 may detect light modulated in the ultrasonic transducer 520a, 520b, . . . , or 520n having a resonance wavelength corresponding to the wavelength of the light generated according to the channel select signal, and convert the detected light signal into an electrical signal.

Referring to FIG. 5B, a photoacoustic ultrasonic sensor 500b may include a first light source 510, a plurality of ultrasonic transducers 520a, 520b, . . . , and 520n, a light sensor 530, and a second light source 550.

The first light source 510 may generate a first light, and perform amplitude modulation on the first light through an ultrasonic signal generated by the signal generator 110.

Sets of transmitters 120 and receivers 130 may form a plurality of channels 540a, 540b, . . . , and 540n, and the plurality of ultrasonic transducers 501, 520b, . . . , and 520n may share one optical waveguide 521. Structures 522a, 522b, . . . , and 522n of the plurality of ultrasonic transducers 520a, 520b, . . . , and 520n may be formed in different sizes. For example, different resonance wavelengths may be achieved by varying the radii of ring resonators.

Additionally, the second light source 550 generates a second light. A channel select signal is input, and the second light source 550 may generate the second light of a corresponding wavelength in response to the channel select signal. The channel select signal may be generated by the processor 160 of FIG. 1. The channel select signal may contain information on the wavelength band of the second light source 550. In addition, the ultrasonic signal generated by the signal generator 110 may be input to the second light source 550, allowing amplitude modulation of the second light.

The light sensor 530 may detect a light signal modulated in the ultrasonic transducer 520a, 520b, . . . , or 520n corresponding to the channel selected by the light source 550. In other words, the light sensor 530 may detect light modulated in the ultrasonic transducer 520a, 520b, . . . , or 520n having a resonance wavelength corresponding to the wavelength of the light generated according to the channel select signal, convert the detected light signal into an electrical signal, and then output the electrical signal.

Referring to FIG. 5C, a photoacoustic ultrasonic sensor 500c may include a first light source 510, a plurality of ultrasonic transducers 520a, 520b, . . . , and 520n, a light sensor 530, and a second light source 550. Here, the second light source 550 may be omitted, and as described with reference to FIG. 5A, the first light source 510 may select a channel.

As illustrated, the plurality of ultrasonic transducers 520a, 520b, . . . , and 520n may include a plurality of optical waveguides 521a, 521b, . . . , and 521n. Each ultrasonic transducer 520a, 520b, . . . , and 520n may include one optical waveguide 521a, 521b, . . . , and 521n, allowing, for example, one-to-one coupling with the resonator of each ultrasonic transducer. However, the embodiment is not limited to this, such that each optical waveguide 521a, 521b, . . . , and 521n may be formed to cover two or more ultrasonic transducers 520a, 520b, . . . , and 520n. Other configurations are described above with reference to FIGS. 5A and 5B, and thus will not be reiterated.

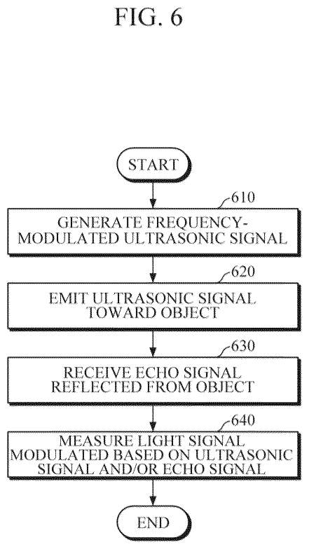

FIG. 6 is a flowchart illustrating a photoacoustic ultrasonic sensor-based sensing method according to an embodiment.

The method of FIG. 6 is an example of a sensing method performed by the sensing apparatus shown in FIG. 1, and thus redundant explanations will be omitted.

A signal generator may generate a frequency-modulated ultrasonic signal in operation 610. The ultrasonic signal may be generated with a frequency bandwidth in units of predetermined pulse widths, based on consideration factors such as target resolution. The generated ultrasonic signal may be inputted to a transmitter and a photoacoustic ultrasonic sensor. The ultrasonic signal may be amplified by an AMP and then input to the transmitter.

The transmitter may emit the ultrasonic signal generated in operation 610 toward an object in operation 620.

The receiver may receive an echo signal reflected from the object in operation 630.

In operation 640, the photoacoustic ultrasonic sensor may modulate the light based on the ultrasonic signal generated in operation 610 and/or the echo signal received in operation 630, and measure a modulated light signal. The ultrasonic signal generated in operation 610 may be synchronized with a driving signal of the transmitter and input to the photoacoustic ultrasonic sensor. In addition, the echo signal received in operation 630 may be input to the photoacoustic ultrasonic sensor, and at this time, it may be amplified by an LNA and input to the photoacoustic ultrasonic sensor. The photoacoustic ultrasonic sensor may be synchronized with the transmitter driving signal to primarily modulate the light using the input ultrasonic signal, and may secondarily modulate the primarily modulated light using the echo signal input from the receiver. The light signal measured by the photoacoustic ultrasonic sensor may be utilized for spatial information reconstruction or image acquisition (e.g., medial ultrasonic image, etc.).

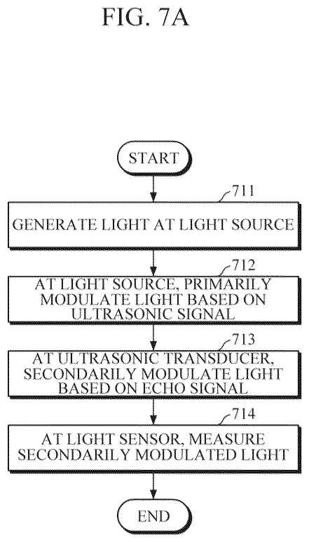

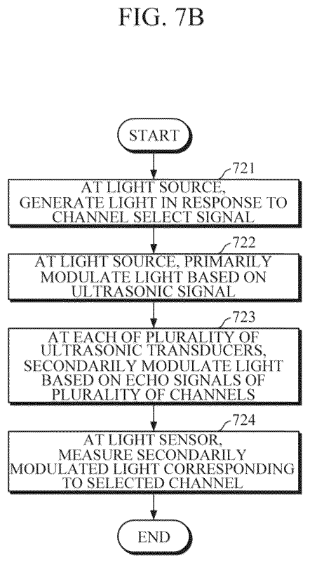

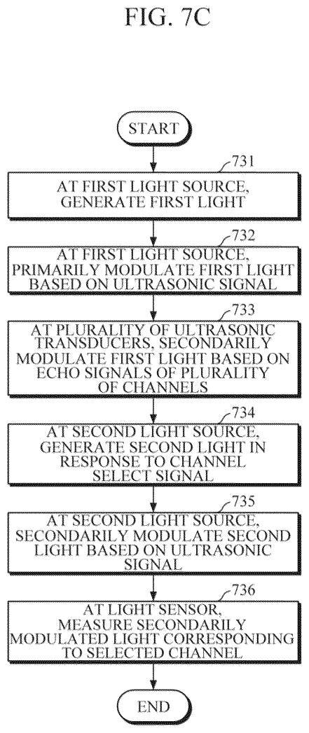

FIGS. 7A to 7C are flowcharts illustrating embodiments of operation 640 of modulating and measuring a light signal by the photoacoustic ultrasonic sensor.

Referring to FIG. 7A, the light source may generate light in operation 711. In this case, the light may be laser light, but is not limited thereto.

In operation 712, the light source may primarily modulate the amplitude of the light generated in operation 711 by using the ultrasonic signal generated in operation 610 of FIG. 6 as input.

In operation 713, the ultrasonic transducer may secondarily modulate the amplitude of the light primarily modulated in operation 712 by using the echo signal received in operation 630 of FIG. 6.

In operation 714, the light sensor may measure an optically mixed light signal modulated in amplitude through the ultrasonic signal and the echo signal in operations 712 and 713.

Referring to FIG. 7B, the light source may generate light based on an input channel select signal in operation 721. The channel select signal may contain information on the wavelength of the light to be generated by the light source. The light source may generate light of a relatively narrow band, specific wavelength in response to the channel select signal.

In operation 722, the light source may primarily modulate the amplitude of the light generated in operation 721 by using the ultrasonic signal generated in operation 610 of FIG. 6 as input.

In operation 723, a plurality of ultrasonic transducers may each secondarily modulate the amplitude of the primarily modulated light using the echo signal received by each channel as input. For example, different resonance wavelengths may be achieved by varying the radii of ring resonators.

In operation 724, the light sensor may measure an optically mixed light signal modulated in amplitude through the ultrasonic signal and the echo signal in operations 722 and 723. In particular, light resonating at a wavelength corresponding to the wavelength of the light generated according to the channel select signal in operation 721 may be detected, and the detected light signal may be converted into an electrical signal.

Referring to FIG. 7C, a first light source may generate first light in operation 731. In this case, the light source may generate light of a relatively broad wavelength range.

In operation 732, the light source may primarily modulate the amplitude of the light generated in operation 731 by using the ultrasonic signal generated in operation 610 of FIG. 6 as input.

In operation 733, a plurality of ultrasonic transducers may secondarily modulate the amplitude of the primarily modulated light using the echo signal received by each channel as input. In this case, structures of the plurality of ultrasonic transducers may be formed in different sizes.

Then, the second light source may generate second light in operation 734. A channel select signal may be input to the second light source, and the second light source may generate the second light of a corresponding wavelength in response to the channel select signal.

In operation 735, the second light source may modulate the amplitude of the light generated in operation 734 by using the ultrasonic signal generated in operation 610 of FIG. 6 as input.

Subsequently, light resonating at a wavelength corresponding to the wavelength of the second light generated according to the channel select signal in operation 734 may be detected, and the detected light signal may be converted into an electrical signal and then output in operation 736.

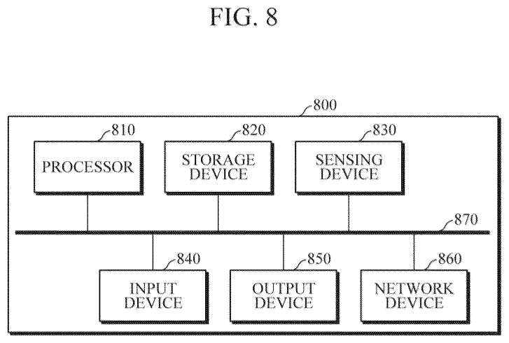

FIG. 8 is a block diagram illustrating an electronic apparatus including a sensing apparatus in accordance with an embodiment.

The electronic apparatus 800 may perform operations and functions of the above-described photoacoustic ultrasonic sensor-based sensing apparatuses 100a and 100b. The electronic apparatus 800 may include image processing devices, radar devices, smartphones, wearable devices, tablet computers, netbook computers, laptop computers, desktop computers, head mounted displays (HMDs), autonomous vehicles, smart vehicles, virtual reality (VR) devices, argument reality (AR) devices, extended reality (XR) devices, automobiles, mobile robots, medical imaging systems, and the like, and may utilize the aforementioned sensing apparatus in autonomous driving systems, flight radar systems, driver assistance systems, object recognition systems, and surveillance/security systems, medical imaging systems, and the like.

The electronic apparatus 800 may include a processor 810, a storage device 820, a sensing device 830, an input device 840, an output device 850, and a network device 860. The processor 810, the storage device 820, the sensing device 830, the input device 840, the output device 850, and the network device 860 may communicate with one another through a communication bus 870.

The processor 810 may execute functions and instructions to be executed by the apparatus 800. The processor 810 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 810 includes one or more processors capable of being programmed to perform a function. For example, the processor 810 may process instructions stored in the storage device 820. The processor 810 may perform one or more of the operations described above.

The storage device 820 stores information and data required for the execution of the processor 810. The storage device 820 may store instructions to be executed by the processor 810. The storage device 820 may include a non-transitory computer-readable storage medium, for example, a random-access memory (RAM), a dynamic RAM (DRAM), a static RAM (SRAM), a magnetic hard disk, an optical disc, a flash memory, an electrically erasable programmable read-only memory (EPROM), a floppy disk, or other types of a computer-readable storage medium that are well-known in the related technical field.

The sensing device 830 may include one or more sensors. For example, the sensing device 830 may include the above-described photoacoustic ultrasound-based sensing apparatus, a radar sensor, an image sensor, and the like.

The input device 840 may receive an input from a user through a tactile input, a video input, an audio input, or a touch input. The input device 840 may include a keyboard, a mouse, a touchscreen, a microphone, and/or other devices that may detect the input from the user and transmit the detected input.

The output device 850 may provide an output of the electronic apparatus 800 to a user through a visual, auditory, or tactile channel. For example, the output device 850 may include a liquid crystal display (LCD), a light-emitting diode (LED) display, a touchscreen, a speaker, a vibration generator, and/or other devices that may provide the user with the output. The output device 850 may provide a result of estimating position information of an object by the processor 810 using any one or any combination of any two or more of visual information, auditory information, or haptic information.

The network device 860 may communicate with an external device through a wired or wireless network. For example, the network device 860 may communicate with the external device through a wired communication method, or a wireless communication method including, for example, Bluetooth communication, Bluetooth low energy (BLE) communication, a near field communication (NFC), WLAN communication, Zigbee communication, infrared data association (IrDA) communication, Wi-Fi direct (WFD) communication, ultra-wideband (UWB) communication, Ant+ communication, WiFi communication, radio frequency identification (RFID) communication, third-generation (3G) communication, 4G communication, 5G communication, direction connection via the internal bus, or the like.

While not restricted thereto, an example embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an example embodiment may be written as a computer program transmitted over a computer-readable transmission medium, such as a carrier wave, and received and implemented in general-use or special-purpose digital computers that execute the programs. Moreover, it is understood that in example embodiments, one or more units of the above-described apparatuses and devices can include circuitry, a processor, a microprocessor, etc., and may execute a computer program stored in a computer-readable medium.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A photoacoustic ultrasonic sensor-based sensing apparatus comprising:
a signal generator configured to generate an ultrasonic signal;
a transmitter configured to emit the ultrasonic signal;
a receiver configured to receive an echo signal that occurs when the ultrasonic signal is reflected from an object; and
a photoacoustic ultrasonic sensor configured to measure a light signal modulated based on at least one of the ultrasonic signal or the echo signal.

2. The photoacoustic ultrasonic sensor-based sensing apparatus of claim 1, wherein the photoacoustic ultrasonic sensor comprises
a light source configured to generate light and modulate the light using the ultrasonic signal to obtain a first modulated light signal,
an ultrasonic transducer configured to modulate the first modulated light based on the echo signal to obtain a second modulated light signal, and
a light sensor configured to measure the second modulated light signal.

3. The photoacoustic ultrasonic sensor-based sensing apparatus of claim 2, wherein the light generated by the light source comprises laser light.

4. The photoacoustic ultrasonic sensor-based sensing apparatus of claim 2, wherein the light source is synchronized with a transmitter driving signal that is output from the signal generator to modulate the light using the ultrasonic signal.

5. The photoacoustic ultrasonic sensor-based sensing apparatus of claim 2, wherein the ultrasonic transducer comprises an optical waveguide configured to transmit the light from the light source to the light sensor.

6. The photoacoustic ultrasonic sensor-based sensing apparatus of claim 5, wherein the ultrasonic transducer further comprises a modulation structure configured to module an amplitude of light moving through the optical waveguide in response to an input of the echo signal.

7. The photoacoustic ultrasonic sensor-based sensing apparatus of claim 6, wherein the modulation structure comprises at least one of a deformable body that undergoes mechanical deformation due to the echo signal, a resonator, and a coupler configured to couple the resonator to the optical waveguide.

8. The photoacoustic ultrasonic sensor-based sensing apparatus of claim 1, further comprising a filter configured to filter the light signal measured by the photoacoustic ultrasonic sensor to output a beat frequency signal.

9. The photoacoustic ultrasonic sensor-based sensing apparatus of claim 1, further comprising an analog-to-digital converter (ADC) configured to convert the light signal measured by the photoacoustic ultrasonic sensor into a digital signal.

10. The photoacoustic ultrasonic sensor-based sensing apparatus of claim 1, further comprising a processor configured to process the light signal measured by the photoacoustic ultrasonic sensor.

11. The photoacoustic ultrasonic sensor-based sensing apparatus of claim 1, wherein
the transmitter and the receiver constitute a plurality of channels, and
the photoacoustic ultrasonic sensor comprises
a first light source configured to generate a first light and modulate the first light based on the ultrasonic signal to obtain a first modulated light signal,
a plurality of ultrasonic transducers configured to modulate the first modulated light signal based on echo signals received from the plurality of channels to obtain a second modulated light signal, and
a light sensor configured to measure the second modulated light signal that is modulated by the plurality of ultrasonic transducers.

12. The photoacoustic ultrasonic sensor-based sensing apparatus of claim 11, wherein the light sensor is configured to measure the second modulated light signal that is obtained by modulating the first modulated light signal using one of the echo signals that is received from a channel selected according to a channel select signal, among the plurality of channels.

13. The photoacoustic ultrasonic sensor-based sensing apparatus of claim 12, wherein the first light source is configured to select the channel by adjusting a wavelength of the first light according to the channel select signal.

14. The photoacoustic ultrasonic sensor-based sensing apparatus of claim 12, further comprising a second light source configured to generate a second light for selecting the channel by adjusting a wavelength of the second light according to the channel select signal.

15. The photoacoustic ultrasonic sensor-based sensing apparatus of claim 14, wherein the second light source is configured to modulate the second light using the ultrasonic signal generated by the signal generator.

16. The photoacoustic ultrasonic sensor-based sensing apparatus of claim 12, wherein sizes of the plurality of ultrasonic transducers are set differently to correspond to different resonance wavelengths.

17. The photoacoustic ultrasonic sensor-based sensing apparatus of claim 11, wherein the plurality of ultrasonic transducers comprise one or more optical waveguides that transmit the first light from the first light source to the light sensor.

18. A photoacoustic ultrasonic sensor-based sensing method comprising:
generating an ultrasonic signal using a signal generator;
emitting, by a transmitter, the ultrasonic signal;
receiving, at a receiver, an echo signal that occurs when the ultrasonic signal is reflected from an object; and
measuring, at a photoacoustic ultrasonic sensor, a light signal modulated based on at least one of the ultrasonic signal or the echo signal.

19. The photoacoustic ultrasonic sensor-based sensing method of claim 18, wherein the measuring of the modulated light signal comprises
modulating the light based on the ultrasonic signal to obtain a first modulated light signal,
modulating the first modulated light signal based on the echo signal to obtain a second modulated light signal, and
measuring the second modulated light signal.

20. An electronic device comprising:
a signal generator configured to generate an ultrasonic signal and output the ultrasonic signal through a first route and a second route;
a transmitter configured to receive the ultrasound signal through the first route and transmit the ultrasound signal outside the electronic device;
a receiver configured to receive an echo signal of the ultrasound signal that is reflected from an object;
an photoacoustic ultrasonic sensor configured to generate a light signal, modulate the light signal based on the ultrasound signal received through the second route to obtain a first modulated light signal, and modulate the first modulation light signal based on the echo signal to obtain a second modulated light signal;
a processor configured to determine a distance to the object based on the second modulated light signal; and
a display configured to display information about the distance to the object.
